(19) United States
(12) Patent Application Publication
(10) Pub. No.: US 2025/0132776 A1
(43) Pub. Date: Apr. 24, 2025

(54) FRONT-END ARCHITECTURES FOR TRANSMISSION SIGNALS

(71) Applicant: Meta Platforms Technologies, LLC, Menlo Park, CA (US)

(72) Inventors: Fei He, Santa Clara, CA (US); Ashok Vijayaraghavan, Kirkland, WA (US)

(21) Appl. No.: 18/400,321

(22) Filed: Dec. 29, 2023

Related U.S. Application Data
(60) Provisional application No. 63/592,656, filed on Oct. 24, 2023.

(51) Int. Cl. H04B 1/00; H04B 1/44

(52) U.S. Cl. CPC H04B 1/0057; H04B 1/44

(57) ABSTRACT

Systems for wireless communication may include a first transmitter for providing a first transmission signal and a second transmitter for providing a second transmission signal. A combiner may receive the first and second transmission signals and combine them into a combined signal. A power amplifier may combine and amplify the combined signal. A diplexer may separate the amplified, combined signal into a first amplified transmission signal corresponding to the first transmission signal and a second amplified transmission signal corresponding to the second transmission signal. At least one antenna may receive and wirelessly transmit the first and second amplified transmission signals. Various other methods, systems, and computer-readable media are also disclosed.

### CROSS REFERENCE TO RELATED APPLICATION

This application claims the benefit of U.S. Provisional Application No. 63/592,656, filed 24 Oct. 2023, the disclosure of which is incorporated, in its entirety, by this reference.

### BRIEF DESCRIPTION OF APPENDICES

The accompanying drawings illustrate a number of example embodiments and are a part of the specification. Together with the following description, these appendices demonstrate and explain various principles of the present disclosure

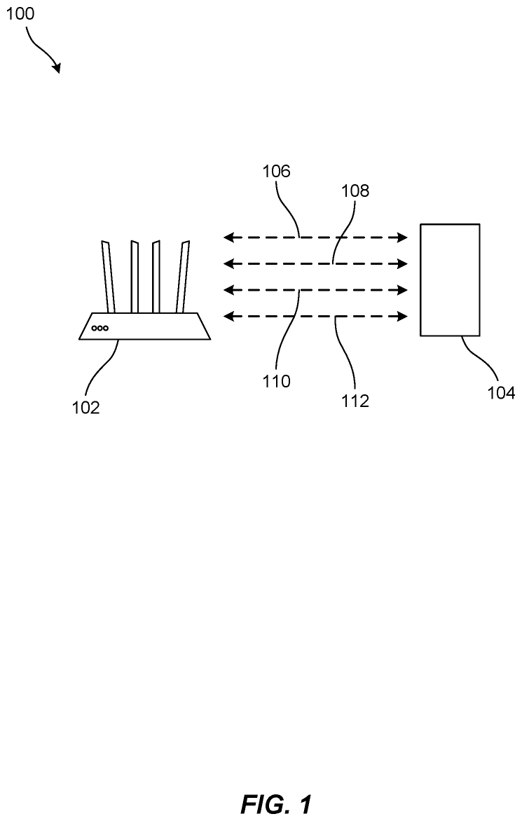

FIG. 1 illustrates a system for wireless communication, according to at least one embodiment of the present disclosure.

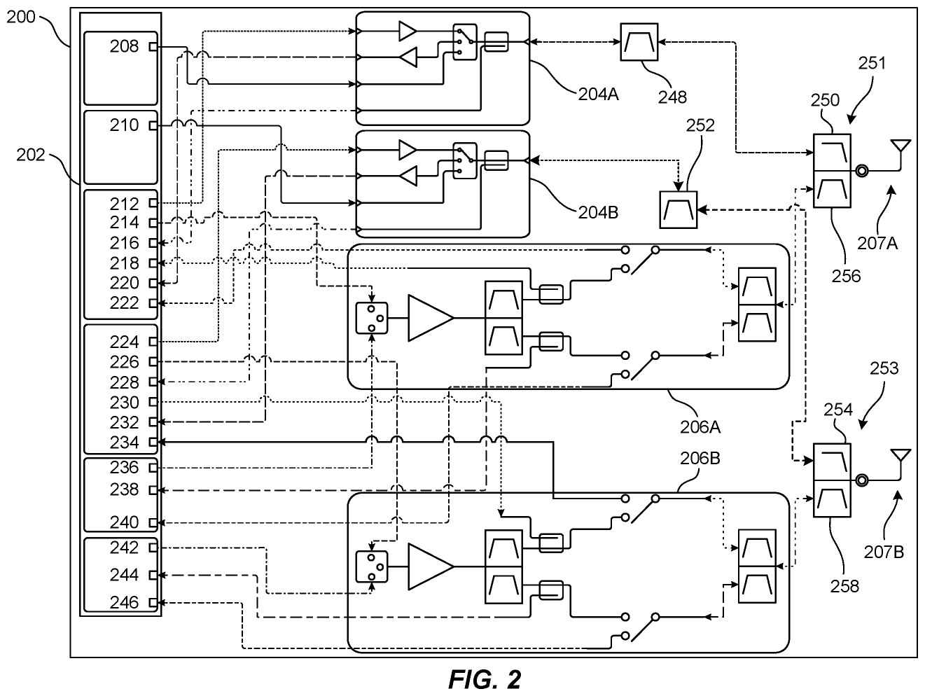

FIG. 2 is a schematic diagram of a system for wireless communication, according to at least one additional embodiment of the present disclosure.

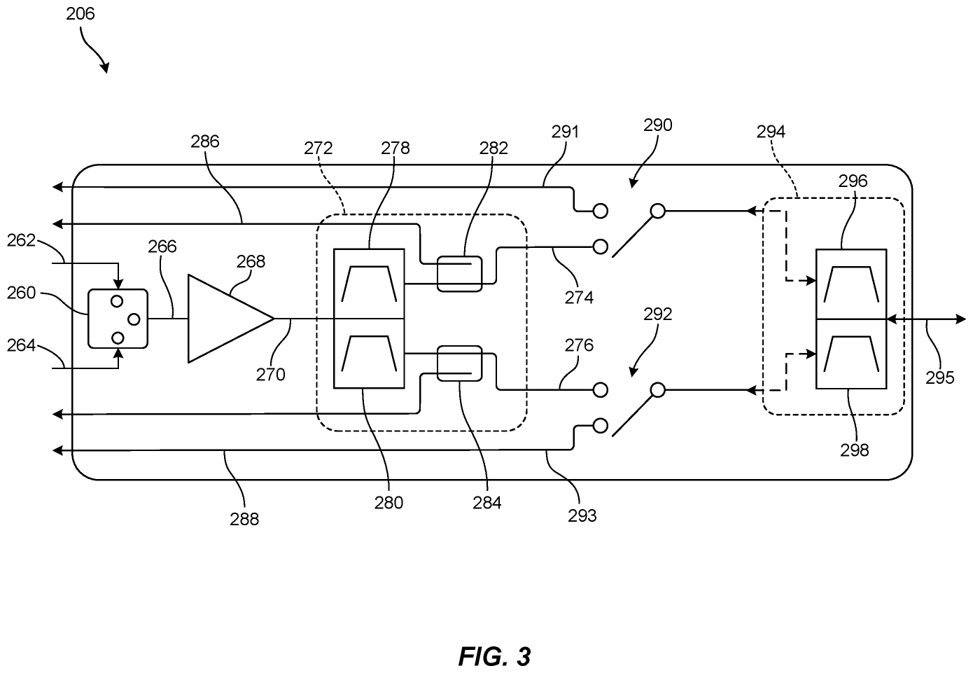

FIG. 3 is a schematic diagram of a high-band front-end module of the system of FIG. 2, according to at least one embodiment of the present disclosure.

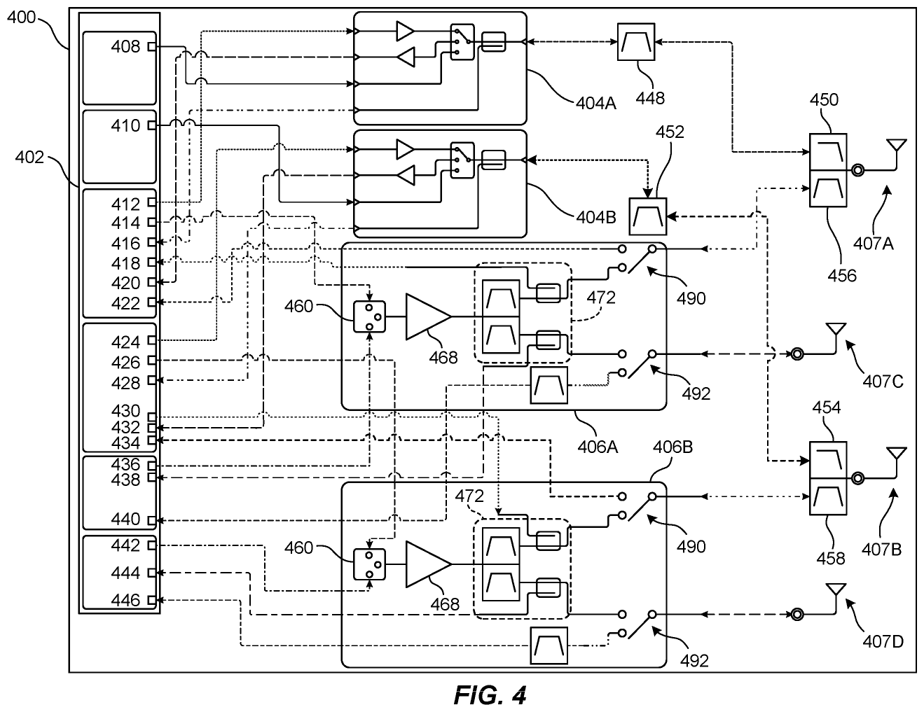

FIG. 4 is a schematic diagram of a system for wireless communication, according to at least one additional embodiment of the present disclosure.

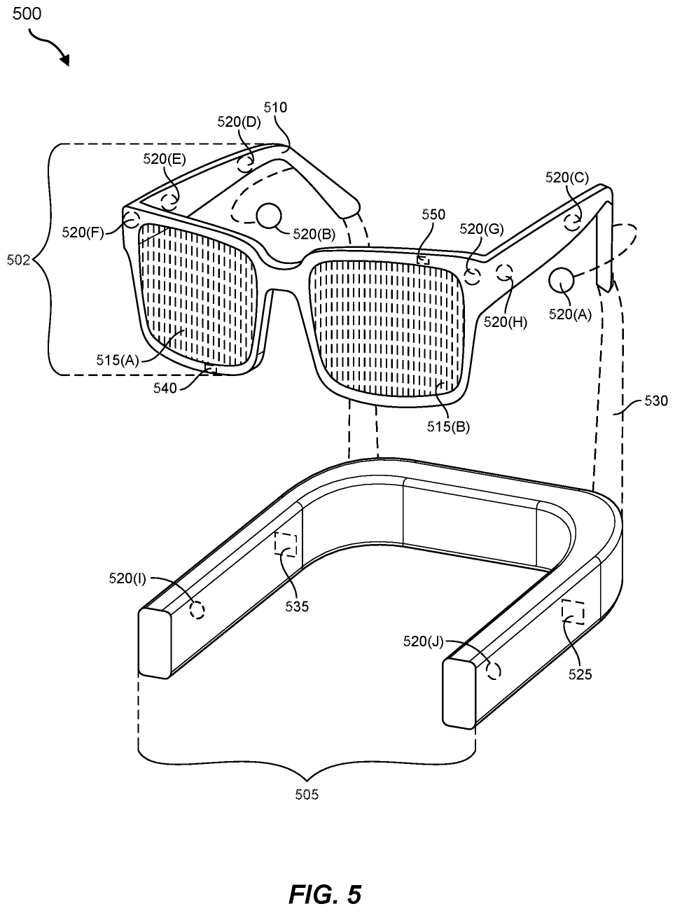

FIG. 5 is an illustration of exemplary augmented-reality glasses that may be used in connection with embodiments of this disclosure.

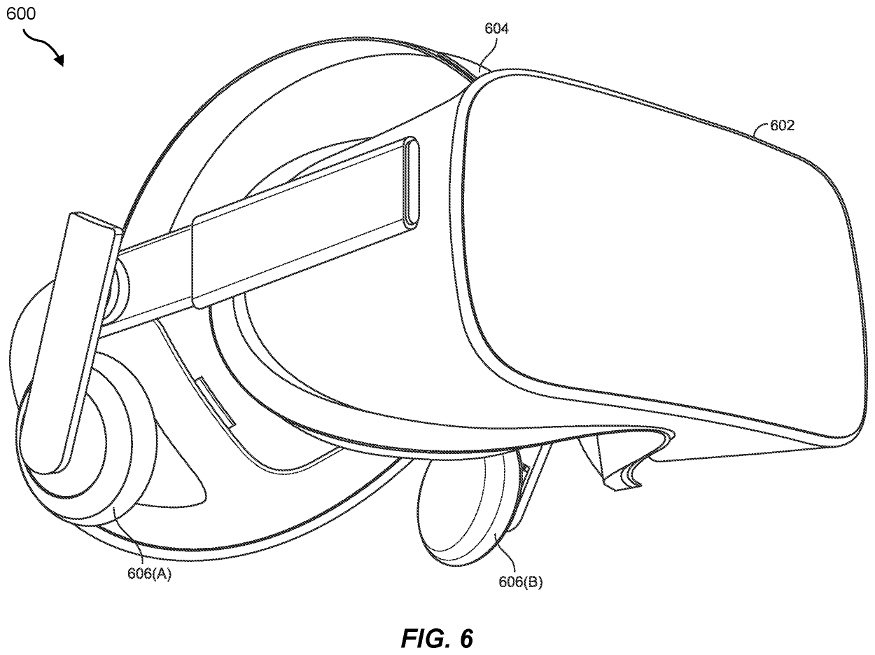

FIG. 6 is an illustration of an exemplary virtual-reality headset that may be used in connection with embodiments of this disclosure.

Throughout the appendices, identical reference characters and descriptions indicate similar, but not necessarily identical, elements. While the example embodiments described herein are susceptible to various modifications and alternative forms, specific embodiments have been shown by way of example in the appendices and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

The present disclosure is generally directed to a low-power, high-bandwidth antenna architecture in which a reduced number of power amplifiers (PAs) may be used to power high-bandwidth antennas. WiFi 7 high band simultaneous (HBS) antenna systems provide ultra-high bandwidth to network devices by using both 5 GHz-range and 6 GHz-range channels simultaneously. In these WiFi 7 systems, each of the 5/6 GHz channels has its own power amplifier. For example, in cases where four antennas are used in WiFi 7 HBS or similar systems, four corresponding power amplifiers would normally be used to drive or power those antennas. Each of these power amplifiers would take up space on a printed circuit board (PCB), would consume power, would generate heat, and would add to the associated electronic device's bill of materials (BOM) cost.

The embodiments described herein may be designed to combine output signals for 5 GHz and 6 GHz channels and send the combined output signal to a single power amplifier. After the combined output signal travels through the power amplifier, a diplexer may be used to separate the 5 GHz and 6 GHz signals and route those signals to a common antenna or to separate antennas (e.g., separate WiFi 7 antennas). Each of these antennas then may operate simultaneously, providing very high levels of bandwidth (e.g., up to 5.8 Gbps of data transfer for the combined link). For embodiments that implement four simultaneous antennas, only two PAS would be needed when using the antenna architectures described herein and as illustrated in the accompanying drawings.

The present disclosure is generally directed to systems for wireless communication. For example, the systems may be implemented as wireless routers, wireless receivers, wireless extenders, or wireless modules of a consumer device, such as a mobile device, a wearable device (e.g., a watch, a fitness tracker, a head-mounted display, smart glasses, etc.), a smart television, an audio speaker, an audio-visual receiver, a desktop computer, a laptop computer, a tablet computer, medical equipment, etc. As will be explained in greater detail below, embodiments of the present disclosure may include at least two transmitters including a first transmitter and a second transmitter that are configured to provide a first transmission signal and a second, different transmission signal, respectively. The system may also include a combiner configured to receive the first and second transmission signals from the first and second transmitters and combine the first and second transmission signals into a single, combined signal. The system may further include a power amplifier configured to receive the combined transmission signal from the combiner and amplify the combined signal. The transmitters, combiner, and power amplifier may be part of a separate front-end module (FEM) that may be plugged into or may replace existing FEMs in electronic devices that already include WiFi 7 HBS or similar radio frequency (RF) architectures.

The system may further include a diplexer that is configured to receive the amplified, combined transmission signal and separate the amplified, combined transmission signal into two different amplified, combined transmission signals that correspond to the first and second transmission signals. As such, the two different amplified transmission signals are amplified versions of the initial first and second transmission signals. The system may also include at least one antenna (e.g., a single antenna or two antennas) that may be fed either a combined amplified transmission signal or the separate amplified transmission signals. From the one or more antennas, the transmission signals may be transmitted to receiving devices such as routers, gateways, cellular communication towers, global positioning systems, or other receiving devices. Although some of the embodiments are described in relation to WiFi 7, these embodiments may be applied with many different types of antennas operating on many different frequency bands. It will further be understood that the systems described herein may also be used in reverse and, instead of or in addition to transmitters, may include receivers, with the received signal being amplified in addition or instead.

In some cases, the combined transmission signal from the combiner may be a two-tone signal having specific properties including from each of the original first and second transmission signals. Additionally or alternatively, the systems herein may include other transmitters including, potentially, third and fourth transmitters that are configured to provide third and fourth transmission signals, respectively. Such a system may also include a second combiner that is configured to receive the third and fourth transmission signals from the third and fourth transmitters and combine the third and fourth transmission signals into a second combined signal.

Still further, embodiments of the present disclosure may include a second power amplifier configured to receive the second combined transmission signal from the second combiner and amplify the second combined signal. The system in such embodiments may also include a second diplexer configured to receive the second amplified, combined transmission signal and separate the second amplified, combined transmission signal into two different amplified, combined transmission signals that correspond to the third and fourth transmission signals. The system may also include at least one more antenna where the two amplified, combined transmission signals are fed to the at least one more antenna. A variety of frequencies may be used for each antenna or antenna pair. Still further, any of the disclosed antennas may be WiFi 7 antennas or may be other types of antennas (e.g., cellular antennas, GPS antennas, BLUETOOTH antennas, near-field communication (NFC) antennas, or antennas that are configured to transmit in a combination of different frequency bands).

Features from any of the embodiments described herein may be used in combination with one another in accordance with the general principles described herein. These and other embodiments, features, and advantages will be more fully understood upon reading the following detailed description in conjunction with the accompanying drawings and claims.

The following will provide, with reference to FIGS. 1-4, detailed descriptions of systems for wireless communications and components thereof, according to various embodiments of the present disclosure. Next, with reference to FIGS. 5 and 6, example artificial-reality systems will be described that may be used in conjunction with embodiments of the present disclosure.

FIG. 1 illustrates a system 100 for wireless communication, according to at least one embodiment of the present disclosure. The system 100 may include a wireless transmitter 102 and a wireless receiver 104. In some examples, the system 100 may be a so-called “high band simultaneous” (HBS) system configured for wireless transmission of data from the wireless transmitter 102 to the wireless receiver 104, and potentially vice versa from the wireless receiver 104 to the wireless transmitter 102. Either or both of the wireless transmitter 102 and the wireless receiver 104 may be implemented as a standalone device or as a component or module of another device, such as of a consumer electronic device.

The system 100 may be adapted for simultaneously transmitting multiple wireless signals. For example, as illustrated in FIG. 1, the system 100 may be configured to simultaneously transmit two, four, or more wireless signals, such as a first 5 GHz-range signal 106, a second 5 GHz-range signal 108, a first 6 GHz-range signal 110, and a second 6 GHz-range signal 112 from the wireless transmitter 102 to the wireless receiver 104. In some embodiments, the system 100 may additionally be configured for transmitting one or more wireless signals in a 2.4 GHz range.

By way of example and not limitation, the 2.4 GHz range may have a frequency range of about 2.400 GHz to about 2.495 GHZ, the 5 GHz range may have a frequency range of about 5.170 GHz to about 5.835 GHZ, and the 6 GHz range may have a frequency range of about 5.925 GHz to about 7.125 GHz. These example frequency ranges are illustrative, and other example ranges may be applicable in various implementations of the present disclosure.

In some examples, the terms “substantially” and “about” in reference to a given parameter, property, or condition, may refer to a degree that one skilled in the art would understand that the given parameter, property, or condition is met with a small degree of variance, such as within acceptable manufacturing tolerances and/or conventional measurement techniques. For example, a parameter that is substantially met may be at least about 90% met, at least about 95% met, at least about 99% met, or fully met.

FIG. 2 is a schematic diagram of a system 200 for wireless communication, according to at least one additional embodiment of the present disclosure. The system 200 may include a signal processing module 202, which may include a variety of transmitters for providing transmission signals, receivers for receiving transmission signals, and power detectors for measuring and controlling the power of the transmission signals in the system 200. The system 200 may also include front-end modules (FEMs) (e.g., a first low-band (e.g., 2.4 GHz-range) FEM 204A, a second low-band FEM 204B, a first high-band (e.g., 5 GHz-range and/or 6 GHz-range) FEM 206A, and a second high-band FEM 206B) for passing various transmission signals between the signal processing module 202 and one or more antennas (e.g., a first antenna 207A and a second antenna 207B).

For example, the signal processing module 202 may include a first BLUETOOTH transmitter 208, a second BLUETOOTH transmitter 210, a first low-band transmitter 212, a first high-band transmitter 214, a first low-band power detector 216, a first high-band power detector 218, a first low-band receiver 220, a first high-band receiver 222, a second low-band transmitter 224, a second high-band transmitter 226, a second low-band power detector 228, a second high-band power detector 230, a second low-band receiver 232, a second high-band receiver 234, a third high-band transmitter 236, a third high-band power detector 238, a third high-band receiver 240, a fourth high-band transmitter 242, a fourth high-band power detector 244, and a fourth high-band receiver 246. These components of the signal processing module 202 are provided by way of example. In other embodiments, additional or fewer elements may be present in the signal processing module 202.

The first low-band FEM 204A may be configured to transmit and/or receive signals to or from the first BLUETOOTH transmitter 208, the first low-band transmitter 212, the first low-band power detector 216, and the first low-band receiver 220. The first low-band FEM 204A may be operably connected to the first antenna 207A to transmit low-band signals to and from the first antenna 207A.

Likewise, the second low-band FEM 204B may be configured to transmit and/or receive signals to or from the second BLUETOOTH transmitter 210, the second low-band transmitter 224, the second low-band power detector 228, and the second low-band receiver 232. The second low-band FEM 204B may be operably connected to the second antenna 207B to transmit low-band signals to and from the second antenna 207B.

The first high-band FEM 206A may be configured to transmit and/or receive signals (e.g., non-overlapping signals that do not overlap in frequency range) to or from the first high-band transmitter 214, first high-band power detector 218, first high-band receiver 222, third high-band transmitter 236, third high-band power detector 238, and third high-band receiver 240. The first high-band FEM 206A may be operably connected to the first antenna 207A to transmit high-band signals to and from the first antenna 207A.

Likewise, the second high-band FEM 206B may be configured to transmit and/or receive signals (e.g., non-overlapping signals that do not overlap in frequency range) to or from the second high-band transmitter 226, second high-band power detector 230, second high-band receiver 234, fourth high-band transmitter 242, fourth high-band power detector 244, and fourth high-band receiver 246. The second high-band FEM 206B may be operably connected to the second antenna 207B to transmit high-band signals to and from the second antenna 207B.

An example high-band FEM 206, which may be used for the first high-band FEM 206A and/or for the second high-band FEM 206B, is shown in FIG. 3 and is further described below.

As illustrated in FIG. 2, the system 200 may be configured to include a total of two antennas 207A, 207B. Each of the antennas 207A, 207B may be configured to transmit and/or receive multiple wireless transmissions in respectively different (e.g., non-overlapping) frequency bands, such as in a 2.4 GHz range, in a 5 GHz range, and/or in a 6 GHz range.

In some examples, a variety of bandpass filters may be employed between the antennas 207A, 207B and the FEMs 204A, 204B, 206A, 206B. For example, a first bandpass filter 248 and a first low-pass filter 250 may be positioned along a signal path between the first low-band FEM 204A and the first antenna 207A such that a low-band signal can be filtered and transmitted between the first low-band FEM 204A and the first antenna 207A. A second bandpass filter 252 and a second low-pass filter 254 may be positioned along a signal path between the second low-band FEM 204B and the second antenna 207B such that a low-band signal can be filtered and transmitted between the second low-band FEM 204B and the second antenna 207B. A third bandpass filter 256 may be positioned along a signal path between the first high-band FEM 206A and the first antenna 207A such that a high-band (e.g., in the 5 GHz range and/or in the 6 GHz range) signal can be filtered and transmitted between the first high-band FEM 206A and the first antenna 207A. A fourth bandpass filter 258 may be positioned along a signal path between the second high-band FEM 206B and the second antenna 207B such that a high-band signal can be filtered and transmitted between the second high-band FEM 206B and the second antenna 207B.

In some examples, the first low-pass filter 250 and the third bandpass filter 256 may be components of a first antenna diplexer 251 associated with the first antenna 207A. Likewise, the second low-pass filter 254 and the fourth bandpass filter 258 may be components of a second antenna diplexer 253 associated with the second antenna 207B.

FIG. 3 is a schematic diagram of a high-band FEM 206 of the system 200 of FIG. 2, according to at least one embodiment of the present disclosure. The high-band FEM 206 may be used as the first high-band FEM 206A and/or as the second high-band FEM 206B of the system 200.

The high-band FEM 206 may include a combiner 260 configured for receiving and combining two transmission signals (e.g., a first transmission signal 262 and a second transmission signal 264) into a combined signal 266. For example, in a case where the high-band FEM 206 is used as the first high-band FEM 206A of the system 200 of FIG. 2, the first transmission signal 262 may be a first high-band transmission signal received by the combiner 260 from the first high-band transmitter 214 and the second transmission signal 264 may be a second high-band transmission signal received by the combiner 260 from the third high-band transmitter 236. The first transmission signal 262 may be in a first frequency range, such as in a 5 GHz range, and the second transmission signal 264 may be in a second, different frequency range, such as in a 6 GHz range. The combined signal 266 may be capable of simultaneously carrying both the first transmission signal 262 and the second transmission signal 264.

In some examples, the combiner 260 may be a power combiner or a diplexer capable of combining two signals with non-overlapping frequencies.

A single power amplifier 268 may receive the combined signal 266 from the combiner 260. The power amplifier 268 may amplify (e.g., strengthen a power of) the combined signal 266 to produce an amplified, combined signal 270.

The amplified, combined signal 270 may be provided to a diplexer 272. The diplexer 272 may be configured to receive the amplified, combined signal 270 and separate the amplified, combined signal 270 into a first amplified transmission signal 274 corresponding to the first transmission signal 262 and a second amplified transmission signal 276 corresponding to the second transmission signal 264. For example, in a case in which the first transmission signal 262 is in the 5 GHz range and the second transmission signal 264 is in the 6 GHz range, the diplexer 272 may include a first diplexer bandpass filter 278 for allowing passage of a transmission signal in the 5 GHz range (e.g., a first portion of the amplified, combined signal 270) and a second diplexer bandpass filter 280 for allowing passage of a transmission signal in the 6 GHz range (e.g., a second portion of the amplified, combined signal 270).

In some embodiments, the diplexer 272 may also include a first coupler 282 along a signal path of the first amplified transmission signal 274 and a second coupler 284 along a signal path of the second amplified transmission signal 276. The first coupler 282 may be configured to transmit a first power detection signal 286 to the first high-band power detector 218 (FIG. 2) and the second coupler 284 may be configured to transmit a second power detection signal 288 to the third high-band power detector 238 (FIG. 2).

A first transmit/receive (TR) switch 290 may be configured to receive the first amplified transmission signal 274 from the diplexer 272 and to transmit a first received signal 291 from the first TR switch 290 to the first high-band receiver 222 (FIG. 2). A second transmit/receive (TR) switch 292 may be configured to receive the second amplified transmission signal 276 from the diplexer 272 and to transmit a second received signal 293 from the second TR switch 292 to the third high-band receiver 240 (FIG. 2). The first TR switch 290 and second TR switch 292 may be operable to switch between a first state (shown in FIG. 3) and a second state. In the first state, the first amplified transmission signal 274 is transmitted from the diplexer 272 through the first TR switch 290 toward the first antenna 207A and the second received signal 293 is transmitted from the first antenna 207A to the third high-band receiver 240. In the second state, the first received signal 291 is transmitted from the first antenna 207A to the first high-band receiver 222 and the second amplified transmission signal 276 is transmitted from the diplexer 272 through the second TR switch 292 toward the first antenna 207A.

In some examples, another diplexer 294 may be positioned and configured to receive the first amplified transmission signal 274 from the first TR switch 290, to receive the second amplified transmission signal 276 from the second TR switch 292, and to combine the first amplified transmission signal 274 and second amplified transmission signal 276 into another combined signal 295 to be passed to the first antenna 207A. In a reverse signal flow direction, the other diplexer 294 may be configured to receive a multi-band received signal from the first antenna 207A and to split the multi-band received signal into the first received signal 291 and the second received signal 293. For example, the other diplexer 294 may include a third diplexer bandpass filter 296 for allowing passage of a transmission signal in the 5 GHz range and a fourth diplexer bandpass filter 298 for allowing passage of a transmission signal in the 6 GHz range.

The high-band FEM 206 may enable the processing of two high-band transmission signals 262, 264 with a single power amplifier 268, rather than with two respective power amplifiers for the two high-band transmission signals 262, 264. This configuration may reduce a cost, size, operating heat production, and/or operating energy usage compared to systems with multiple power amplifiers for multiple respective transmission signals.

FIGS. 2 and 3 illustrate systems and components for multiple wireless transmissions (e.g., HBS transmissions) that employ two antennas. However, the present disclosure is not limited to systems with two antennas. For example, a similar system that employs four antennas will next be described with reference to FIG. 4.

FIG. 4 is a schematic diagram of a system 400 for wireless communication, according to at least one additional embodiment of the present disclosure. In some respects, the system 400 of FIG. 4 may be similar to the system 200 of FIG. 2. For example, the system 400 may include a signal processing module 402, a first low-band FEM 404A, a second low-band FEM 404B, a first high-band FEM 406A, and a second high-band FEM 406B.

The signal processing module 402 may include a variety of transmitters, receivers, and power detectors, such as a first BLUETOOTH transmitter 408, a second BLUETOOTH transmitter 410, a first low-band transmitter 412, a first high-band transmitter 414, a first 2.4 GHz-range power detector 416, a first high-band power detector 418, a first 2.4 GHz-range receiver 420, a first high-band receiver 422, a second 2.4 GHz-range transmitter 424, a second high-band transmitter 426, a second 2.4 GHz-range power detector 428, a second high-band power detector 430, a second 2.4 GHz-range receiver 432, a second high-band receiver 434, a third high-band transmitter 436, a third high-band power detector 438, a third high-band receiver 440, a fourth high-band transmitter 442, a fourth high-band power detector 444, and a fourth high-band receiver 446.

As illustrated in FIG. 4, the system 400 may include four antennas for transmitting wireless signals, including a first antenna 407A, a second antenna 407B, a third antenna 407C, and a fourth antenna 407D.

The first antenna 407A may be configured to receive low-band signals from the first BLUETOOTH transmitter 408, the first low-band transmitter 412, the first low-band power detector 416, and the first low-band receiver 420 through the first low-band FEM 404A. In some examples, a first bandpass filter 448 and a first low-pass filter 450 may be positioned along a signal path between the first low-band FEM 404A and the first antenna 407A to allow a low-band transmission signal to pass between the first low-band FEM 404A and the first antenna 407A. Additionally, the first antenna 407A may be configured to receive high-band transmission signals from the first high-band transmitter 414 and third high-band transmitter 436 through the first high-band FEM 406A. In some examples, a third bandpass filter 456 may be positioned along a signal path between the first high-band FEM 406A and the first antenna 407A to allow a high-band transmission signal to pass between the first high-band FEM 406A and the first antenna 407A.

The second antenna 407B may be configured to receive low-band signals from the second BLUETOOTH transmitter 410, the second low-band transmitter 424, the second low-band power detector 428, and the second low-band receiver 432 through the second low-band FEM 404B. In some examples, a second bandpass filter 452 and a second low-pass filter 454 may be positioned along a signal path between the second low-band FEM 404B and the second antenna 407B to allow a low-band transmission signal to pass between the second low-band FEM 404B and the second antenna 407B. Additionally, the second antenna 407B may be configured to receive high-band transmission signals from the second high-band transmitter 426 and fourth high-band transmitter 442 through the second high-band FEM 406B.

In some examples, a fourth bandpass filter 458 may be positioned along a signal path between the second high-band FEM 406B and the second antenna 407B to allow a high-band transmission signal to pass between the second high-band FEM 406B and the second antenna 407B.

The third antenna 407C may be configured to, through the first high-band FEM 406A, receive high-band signals from the third high-band transmitter 436 and/or to transmit high-band signals to the third high-band receiver 440.

The fourth antenna 407D may be configured to, through the second high-band FEM 406B, receive high-band signals from the fourth high-band transmitter 442 and/or to transmit high-band signals to the fourth high-band receiver 446.

Each of the first high-band FEM 406A and second high-band FEM 406B may include a combiner 460 configured for receiving and combining two transmission signals into a combined signal. For example, the combiner 460 of the first high-band FEM 406A may receive a first transmission signal from the first high-band transmitter 414 and a second transmission signal from the third high-band transmitter 436. Similarly, the combiner 460 of the second high-band FEM 406B may receive a first transmission signal from the second high-band transmitter 426 and a second transmission signal from the fourth high-band transmitter 442. In either case, the combined signal may be sent from the combiner 460 to a single power amplifier 468 to be amplified. An amplified, combined signal may be passed from the single power amplifier 468 to a diplexer 472, which may split the amplified, combined signal into a first amplified transmission signal corresponding to the first transmission signal and a second amplified transmission signal corresponding to the second transmission signal. A first TR switch 490 may receive the first transmission signal from the diplexer 472 and a second TR switch 492 may receive the second transmission signal from the diplexer 472.

In the case of the first high-band FEM 406A, the first transmission signal may be received by the first antenna 407A from the first switch 490 of the first high-band FEM 406A (e.g., through the third bandpass filter 456) and the second transmission signal may be received by the third antenna 407C from the second switch 492 of the first high-band FEM 406A.

In the case of the second high-band FEM 406B, the first transmission signal may be received by the second antenna 407B from the first switch 490 of the second high-band FEM 406B (e.g., through the fourth bandpass filter 458) and the second transmission signal may be received by the fourth antenna 407D from the second switch 492 of the second high-band FEM 406B.

Compared to the high-band FEM 206 of FIG. 3, each of the first high-band FEM 406A and second high-band FEM 406B may lack the other diplexer 294 that recombines the first amplified transmission signal 274 and second amplified transmission signal 276. In the system 400 of FIG. 4, this other diplexer 294 may be omitted from the first high-band FEM 406A and second high-band FEM 406B due to the use of the four antennas 407A, 407B, 407C, and 407D in the system 400 rather than the two antennas 207A and 207B of the system 200 of FIG. 2.

Accordingly, the present disclosure includes systems that can be used for HBS wireless communication. The disclosed systems may include a combiner that combines two transmission signals into a combined signal, a single power amplifier to amplify the combined signal, and a diplexer to separate the amplified, combined signal into two amplified transmission signals respectively corresponding to the two transmission signals received by the combiner. Such systems may reduce a cost, heat, and space of systems for wireless communication by, for example, only using a single power amplifier for multiple transmission signals.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 500 in FIG. 5) or that visually immerses a user in an artificial reality (such as, e.g., virtual-reality system 600 in FIG. 6). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 5, the augmented-reality system 500 may include an eyewear device 502 with a frame 510 configured to hold a left display device 515(A) and a right display device 515(B) in front of a user's eyes. The display devices 515(A) and 515(B) may act together or independently to present an image or series of images to a user. While the augmented-reality system 500 includes two displays, embodiments of this disclosure may be implemented in augmented-reality systems with a single NED or more than two NEDs.

In some embodiments, the augmented-reality system 500 may include one or more sensors, such as sensor 540. The sensor 540 may generate measurement signals in response to motion of the augmented-reality system 500 and may be located on substantially any portion of the frame 510. The sensor 540 may represent one or more of a variety of different sensing mechanisms, such as a position sensor, an inertial measurement unit (IMU), a depth camera assembly, a structured light emitter and/or detector, or any combination thereof. In some embodiments, the augmented-reality system 500 may or may not include the sensor 540 or may include more than one sensor. In embodiments in which the sensor 540 includes an IMU, the IMU may generate calibration data based on measurement signals from the sensor 540. Examples of the sensor 540 may include, without limitation, accelerometers, gyroscopes, magnetometers, other suitable types of sensors that detect motion, sensors used for error correction of the IMU, or some combination thereof.

In some examples, the augmented-reality system 500 may also include a microphone array with a plurality of acoustic transducers 520(A)-520(J), referred to collectively as acoustic transducers 520. The acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on the frame 510, and/or acoustic transducers 520(I) and 520(J), which may be positioned on a corresponding neckband 505.

In some embodiments, one or more of the acoustic transducers 520(A)-(J) may be used as output transducers (e.g., speakers). For example, the acoustic transducers 520(A) and/or 520(B) may be earbuds or any other suitable type of headphone or speaker.

The configuration of the acoustic transducers 520 of the microphone array may vary. While the augmented-reality system 500 is shown in FIG. 5 as having ten acoustic transducers 520, the number of acoustic transducers 520 may be greater or less than ten. In some embodiments, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on the frame 510, an orientation associated with each acoustic transducer 520, or some combination thereof.

The acoustic transducers 520(A) and 520(B) may be positioned on different parts of the user's ear, such as behind the pinna, behind the tragus, and/or within the auricle or fossa. Or, there may be additional acoustic transducers 520 on or surrounding the ear in addition to the acoustic transducers 520 inside the ear canal. Having an acoustic transducer 520 positioned next to an ear canal of a user may enable the microphone array to collect information on how sounds arrive at the ear canal. By positioning at least two of the acoustic transducers 520 on either side of a user's head (e.g., as binaural microphones), the augmented-reality device 500 may simulate binaural hearing and capture a 3D stereo sound field around about a user's head. In some embodiments, the acoustic transducers 520(A) and 520(B) may be connected to the augmented-reality system 500 via a wired connection 530, and in other embodiments acoustic transducers 520(A) and 520(B) may be connected to the augmented-reality system 500 via a wireless connection (e.g., a BLUETOOTH connection). In still other embodiments, the acoustic transducers 520(A) and 520(B) may not be used at all in conjunction with the augmented-reality system 500.

The acoustic transducers 520 on the frame 510 may be positioned in a variety of different ways, including along the length of the temples, across the bridge, above or below the display devices 515(A) and 515(B), or some combination thereof. The acoustic transducers 520 may also be oriented such that the microphone array is able to detect sounds in a wide range of directions surrounding the user wearing the augmented-reality system 500. In some embodiments, an optimization process may be performed during manufacturing of the augmented-reality system 500 to determine relative positioning of each acoustic transducer 520 in the microphone array.

In some examples, the augmented-reality system 500 may include or be connected to an external device (e.g., a paired device), such as the neckband 505. The neckband 505 generally represents any type or form of paired device. Thus, the following discussion of the neckband 505 may also apply to various other paired devices, such as charging cases, smart watches, smart phones, wrist bands, other wearable devices, hand-held controllers, tablet computers, laptop computers, other external compute devices, etc.

As shown, the neckband 505 may be coupled to the eyewear device 502 via one or more connectors. The connectors may be wired or wireless and may include electrical and/or non-electrical (e.g., structural) components. In some cases, the eyewear device 502 and neckband 505 may operate independently without any wired or wireless connection between them. While FIG. 5 illustrates the components of the eyewear device 502 and neckband 505 in example locations on the eyewear device 502 and neckband 505, the components may be located elsewhere and/or distributed differently on the eyewear device 502 and/or neckband 505. In some embodiments, the components of the eyewear device 502 and neckband 505 may be located on one or more additional peripheral devices paired with the eyewear device 502, neckband 505, or some combination thereof.

Pairing external devices, such as the neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of the augmented-reality system 500 may be provided by a paired device or shared between a paired device and an eyewear device, thus reducing the weight, heat profile, and form factor of the eyewear device overall while still retaining desired functionality. For example, the neckband 505 may allow components that would otherwise be included on an eyewear device to be included in the neckband 505 since users may tolerate a heavier weight load on their shoulders than they would tolerate on their heads. The neckband 505 may also have a larger surface area over which to diffuse and disperse heat to the ambient environment. Thus, the neckband 505 may allow for greater battery and computation capacity than might otherwise have been possible on a stand-alone eyewear device. Since weight carried in the neckband 505 may be less invasive to a user than weight carried in the eyewear device 502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

The neckband 505 may be communicatively coupled with the eyewear device 502 and/or to other devices. These other devices may provide certain functions (e.g., tracking, localizing, depth mapping, processing, storage, etc.) to the augmented-reality system 500. In the embodiment of FIG. 5, the neckband 505 may include two acoustic transducers (e.g., 520(I) and 520(J)) that are part of the microphone array (or potentially form their own microphone subarray). The neckband 505 may also include a controller 525 and a power source 535.

The acoustic transducers 520(1) and 520(J) of the neckband 505 may be configured to detect sound and convert the detected sound into an electronic format (analog or digital). In the embodiment of FIG. 5, the acoustic transducers 520(I) and 520(J) may be positioned on the neckband 505, thereby increasing the distance between the neckband acoustic transducers 520(I) and 520(J) and other acoustic transducers 520 positioned on the eyewear device 502. In some cases, increasing the distance between the acoustic transducers 520 of the microphone array may improve the accuracy of beamforming performed via the microphone array. For example, if a sound is detected by the acoustic transducers 520(C) and 520(D) and the distance between the acoustic transducers 520(C) and 520(D) is greater than, e.g., the distance between the acoustic transducers 520(D) and 520(E), the determined source location of the detected sound may be more accurate than if the sound had been detected by the acoustic transducers 520(D) and 520(E).

The controller 525 of the neckband 505 may process information generated by the sensors on the neckband 505 and/or augmented-reality system 500. For example, the controller 525 may process information from the microphone array that describes sounds detected by the microphone array. For each detected sound, the controller 525 may perform a direction-of-arrival (DOA) estimation to estimate a direction from which the detected sound arrived at the microphone array. As the microphone array detects sounds, the controller 525 may populate an audio data set with the information. In embodiments in which the augmented-reality system 500 includes an inertial measurement unit, the controller 525 may compute all inertial and spatial calculations from the IMU located on the eyewear device 502. A connector may convey information between the augmented-reality system 500 and the neckband 505 and between the augmented-reality system 500 and the controller 525. The information may be in the form of optical data, electrical data, wireless data, or any other transmittable data form. Moving the processing of information generated by the augmented-reality system 500 to the neckband 505 may reduce weight and heat in the eyewear device 502, making it more comfortable to the user.

The power source 535 in the neckband 505 may provide power to the eyewear device 502 and/or to the neckband 505. The power source 535 may include, without limitation, lithium-ion batteries, lithium-polymer batteries, primary lithium batteries, alkaline batteries, or any other form of power storage. In some cases, the power source 535 may be a wired power source. Including the power source 535 on the neckband 505 instead of on the eyewear device 502 may help better distribute the weight and heat generated by the power source 535.

As noted, some artificial-reality systems may, instead of blending an artificial reality with actual reality, substantially replace one or more of a user's sensory perceptions of the real world with a virtual experience. One example of this type of system is a head-worn display system, such as the virtual-reality system 600 in FIG. 6, that mostly or completely covers a user's field of view. The virtual-reality system 600 may include a front rigid body 602 and a band 604 shaped to fit around a user's head. The virtual-reality system 600 may also include output audio transducers 606(A) and 606(B). Furthermore, while not shown in FIG. 6, the front rigid body 602 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in the augmented-reality system 500 and/or the virtual-reality system 600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in the augmented-reality system 500 and/or the virtual-reality system 600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, the augmented-reality system 500 and/or the virtual-reality system 600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The following example embodiments are also included in the present disclosure:

Example 1. A system, including: a first transmitter configured to provide a first transmission signal; a second transmitter configured to provide a second, different transmission signal; a combiner configured to receive the first and second transmission signals from the first and second transmitters and combine the first and second transmission signals into a combined signal; a power amplifier configured to receive the combined signal from the combiner and amplify the combined signal; a diplexer configured to receive the amplified, combined signal and separate the amplified, combined signal into a first amplified transmission signal corresponding to the first transmission signal and a second amplified transmission signal corresponding to the second transmission signal; and at least one antenna configured to receive, from the diplexer, the first and second amplified transmission signals and to wirelessly transmit the first and second amplified transmission signals.

Example 2. The system of Example 1, wherein the at least one antenna includes: a first antenna configured to receive the first amplified transmission signal from the diplexer; and a second antenna configured to receive the second amplified transmission signal from the diplexer.

Example 3. The system of Example 1 or Example 2, further including: a first transmit/receive switch configured to receive the first amplified transmission signal from the diplexer; and a second transmit/receive switch configured to receive the second amplified transmission signal from the diplexer.

Example 4. The system of Example 3, further including another diplexer configured to: receive the first amplified transmission signal from the first transmit/receive switch; receive the second amplified transmission signal from the second transmit/receive switch; combine the first amplified transmission signal and the second amplified transmission signal into another combined signal; and pass the other combined signal to the at least one antenna.

Example 5. The system of Example 4, wherein the at least one antenna is a single antenna.

Example 6. The system of Example 3, wherein the at least one antenna includes: a first antenna configured to receive the first amplified transmission signal from the first transmit/receive switch; and a second antenna configured to receive the second amplified transmission signal from the second transmit/receive switch.

Example 7. The system of any one of Examples 1 through 6, wherein the first transmission signal is in a first frequency range and the second transmission signal is in a second frequency range.

Example 8. The system of Example 7, wherein the first frequency range is about 5.170 GHz to about 5.835 GHz and the second frequency range is about 5.925 GHz to about 7.125 GHz.

Example 9. The system of Example 7 or Example 8, wherein the diplexer includes: a first bandpass filter that allows a first portion of the amplified, combined signal in the first frequency range to pass to a first output; and a second bandpass filter that allows a second portion of the amplified, combined signal in the second frequency range to pass to a second output.

Example 10. The system of any one of Examples 1 through 9, further including: a third transmitter configured to provide a third transmission signal; a fourth transmitter configured to provide a fourth transmission signal; an additional combiner configured to receive the third and fourth transmission signals from the third and fourth transmitters and combine the third and fourth transmission signals into an additional combined signal; an additional power amplifier configured to receive the additional combined signal from the additional combiner and amplify the additional combined signal; an additional diplexer configured to receive the amplified, additional combined signal and separate the amplified, additional combined signal into a third amplified transmission signal corresponding to the third transmission signal and a fourth amplified transmission signal corresponding to the fourth transmission signal; and at least one additional antenna configured to receive the third and fourth amplified transmission signals and to wirelessly transmit the third and fourth amplified transmission signals.

Example 11. The system of Example 10, wherein the at least one additional antenna includes at least two additional antennas respectively configured to receive the third and fourth amplified transmission signals.

Example 12. The system of Example 10, wherein the at least one additional antenna is a single additional antenna.

Example 13. The system of any one of Examples 10 through 12, wherein the third transmission signal is in a frequency range of about 5.170 GHz to about 5.835 GHz and the fourth transmission signal is in a frequency range of about 5.925 GHz to about 7.125 GHz.

Example 14. The system of any one of Examples 10 through 10, wherein: the first transmission signal and the third transmission signal are in a first frequency range; and the second transmission signal and the fourth transmission signal are in a second, different frequency range.

Example 15. A system, including: a first transmitter configured to provide a first transmission signal in a first frequency range; a second transmitter configured to provide a second transmission signal in a second frequency range that is non-overlapping with the first frequency range; a combiner configured to receive a first transmission signal and a second transmission signal and to combine the first transmission signal and the second transmission signal into a combined signal; a single power amplifier configured to receive the combined signal from the combiner and amplify the combined signal; a diplexer configured to receive and separate the amplified, combined signal into a first amplified transmission signal in the first frequency range and a second amplified transmission signal in the second frequency range; and at least one antenna configured to receive the first and second amplified transmission signals and to wirelessly transmit the first and second amplified transmission signals.

Example 16. The system of Example 15, wherein the first frequency range is about 5.170 GHz to about 5.835 GHz and the second frequency range is about 5.925 GHz to about 7.125 GHz.

Example 17. The system of Example 15 or Example 16, wherein the at least one antenna includes a single antenna.

Example 18. The system of Example 17, wherein the single antenna is further configured to transmit a third transmission signal in a third frequency range that is non-overlapping with both the first frequency range and second frequency range.

Example 19. The system of Example 18, further including: a third transmitter configured to provide the third transmission signal; and a low-band front-end module configured to receive the third transmission signal from the third transmitter, wherein the single antenna is configured to receive the third transmission signal from the low-band front-end module and to wirelessly transmit the third transmission signal.

Example 20. A system, including: a first combiner configured to combine a first transmission signal and a second, different transmission signal into a first combined signal; a first power amplifier configured to amplify the first combined signal; a first diplexer configured to separate the amplified first combined signal into a first amplified transmission signal and a second amplified transmission signal; a first antenna configured to wirelessly transmit the first and second amplified transmission signals; a second combiner configured to combine a third transmission signal and a fourth, different transmission signal into a second combined signal; a second power amplifier configured to amplify the second combined signal; a second diplexer configured to separate the amplified second combined signal into a third amplified transmission signal and a fourth amplified transmission signal; and a second antenna configured to wirelessly transmit the third and fourth amplified transmission signals.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system, comprising:
a first transmitter configured to provide a first transmission signal;
a second transmitter configured to provide a second, different transmission signal;
a combiner configured to receive the first and second transmission signals from the first and second transmitters and combine the first and second transmission signals into a combined signal;
a power amplifier configured to receive the combined signal from the combiner and amplify the combined signal;
a diplexer configured to receive the amplified, combined signal and separate the amplified, combined signal into a first amplified transmission signal corresponding to the first transmission signal and a second amplified transmission signal corresponding to the second transmission signal; and
at least one antenna configured to receive, from the diplexer, the first and second amplified transmission signals and to wirelessly transmit the first and second amplified transmission signals.

2. The system of claim 1, wherein the at least one antenna comprises:
a first antenna configured to receive the first amplified transmission signal from the diplexer; and
a second antenna configured to receive the second amplified transmission signal from the diplexer.

3. The system of claim 1, further comprising:
a first transmit/receive switch configured to receive the first amplified transmission signal from the diplexer; and
a second transmit/receive switch configured to receive the second amplified transmission signal from the diplexer.

4. The system of claim 3, further comprising another diplexer configured to:
receive the first amplified transmission signal from the first transmit/receive switch;
receive the second amplified transmission signal from the second transmit/receive switch;
combine the first amplified transmission signal and the second amplified transmission signal into another combined signal; and
pass the other combined signal to the at least one antenna.

5. The system of claim 4, wherein the at least one antenna is a single antenna.

6. The system of claim 3, wherein the at least one antenna comprises:
a first antenna configured to receive the first amplified transmission signal from the first transmit/receive switch; and
a second antenna configured to receive the second amplified transmission signal from the second transmit/receive switch.

7. The system of claim 1, wherein the first transmission signal is in a first frequency range and the second transmission signal is in a second frequency range.

8. The system of claim 7, wherein the first frequency range is about 5.170 GHz to about 5.835 GHz and the second frequency range is about 5.925 GHz to about 7.125 GHZ.

9. The system of claim 7, wherein the diplexer comprises:
a first bandpass filter that allows a first portion of the amplified, combined signal in the first frequency range to pass to a first output; and
a second bandpass filter that allows a second portion of the amplified, combined signal in the second frequency range to pass to a second output.

10. The system of claim 1, further comprising:
a third transmitter configured to provide a third transmission signal;
a fourth transmitter configured to provide a fourth transmission signal;
an additional combiner configured to receive the third and fourth transmission signals from the third and fourth transmitters and combine the third and fourth transmission signals into an additional combined signal;
an additional power amplifier configured to receive the additional combined signal from the additional combiner and amplify the additional combined signal;
an additional diplexer configured to receive the amplified, additional combined signal and separate the amplified, additional combined signal into a third amplified transmission signal corresponding to the third transmission signal and a fourth amplified transmission signal corresponding to the fourth transmission signal; and
at least one additional antenna configured to receive the third and fourth amplified transmission signals and to wirelessly transmit the third and fourth amplified transmission signals.

11. The system of claim 10, wherein the at least one additional antenna comprises at least two additional antennas respectively configured to receive the third and fourth amplified transmission signals.

12. The system of claim 10, wherein the at least one additional antenna is a single additional antenna.

13. The system of claim 10, wherein the third transmission signal is in a frequency range of about 5.170 GHz to about 5.835 GHz and the fourth transmission signal is in a frequency range of about 5.925 GHz to about 7.125 GHz.

14. The system of claim 10, wherein:
the first transmission signal and the third transmission signal are in a first frequency range; and
the second transmission signal and the fourth transmission signal are in a second, different frequency range.

15. A system, comprising:
a first transmitter configured to provide a first transmission signal in a first frequency range;
a second transmitter configured to provide a second transmission signal in a second frequency range that is non-overlapping with the first frequency range;
a combiner configured to receive a first transmission signal and a second transmission signal and to combine the first transmission signal and the second transmission signal into a combined signal;
a single power amplifier configured to receive the combined signal from the combiner and amplify the combined signal;
a diplexer configured to receive and separate the amplified, combined signal into a first amplified transmission signal in the first frequency range and a second amplified transmission signal in the second frequency range; and
at least one antenna configured to receive the first and second amplified transmission signals and to wirelessly transmit the first and second amplified transmission signals.

16. The system of claim 15, wherein the first frequency range is about 5.170 GHz to about 5.835 GHz and the second frequency range is about 5.925 GHz to about 7.125 GHZ.

17. The system of claim 15, wherein the at least one antenna comprises a single antenna.

18. The system of claim 17, wherein the single antenna is further configured to transmit a third transmission signal in a third frequency range that is non-overlapping with both the first frequency range and second frequency range.

19. The system of claim 18, further comprising:
a third transmitter configured to provide the third transmission signal; and
a low-band front-end module configured to receive the third transmission signal from the third transmitter,
wherein the single antenna is configured to receive the third transmission signal from the low-band front-end module and to wirelessly transmit the third transmission signal.

20. A system, comprising:
a first combiner configured to combine a first transmission signal and a second, different transmission signal into a first combined signal;
a first power amplifier configured to amplify the first combined signal;
a first diplexer configured to separate the amplified first combined signal into a first amplified transmission signal and a second amplified transmission signal;
a first antenna configured to wirelessly transmit the first and second amplified transmission signals;
a second combiner configured to combine a third transmission signal and a fourth, different transmission signal into a second combined signal;
a second power amplifier configured to amplify the second combined signal;
a second diplexer configured to separate the amplified second combined signal into a third amplified transmission signal and a fourth amplified transmission signal; and
a second antenna configured to wirelessly transmit the third and fourth amplified transmission signals.
